(19) United States
(12) Patent Application Publication
(10) Pub. No.: US 2021/0230404 A1
(43) Pub. Date: Jul. 29, 2021

(54) THERMALLY EXPANDABLE RUBBER COMPOSITION

(71) Applicant: SIKA TECHNOLOGY AG, Baar (CH)

(72) Inventors: Christian EYHOLZER, Rochester Hills, MI (US); Goran CAKIC, Zürich (CH); Cornelia BÖFER, Effretikon (CH); Michael GUTGSELL, Uster (CH)

(73) Assignee: SIKA TECHNOLOGY AG, Baar (CH)

(21) Appl. No.: 17/263,976

(22) PCT Filed: Sep. 2, 2019
(86) PCT No.: PCT/EP2019/073301

§ 371 Date: Jan. 28, 2021

(30) Foreign Application Priority Data
Sep. 3, 2018 (EP) 18192305.3

(51) Int. Cl. C08L 9/06; C08J 9/10; C08L 91/02

(52) U.S. Cl. CPC C08L 9/06; C08J 9/108; C08K 5/12; C08J 2309/06; C08L 91/02

(57) ABSTRACT

A thermally expandable rubber composition, including a) at least one solid rubber A from the group consisting of styrene-butadiene rubber, cis-1,4-polybutadiene, synthetic isoprene rubber, natural rubber, ethylene-propylene-diene rubber (EPDM), nitrile rubber, butyl rubber and acrylic rubber; b) processing oil PO, comprising at least one Treated Distillate Aromatic Extract (TDAE); c) at least one vulcanization system VS; d) at least one filler G; e) at least one blowing agent BA. The thermally expandable rubber composition provides low VOC content and exhibits good applicability as well as other material properties after full curing, especially above 200° C. for 40 min, especially good adhesion on substrates, especially metal substrates.

### TECHNICAL FIELD

The present invention relates to a thermally expandable rubber composition, comprising at least a solid rubber A, a processing oil PO, a vulcanization system VS, a filler G and a blowing agent BA as well as a method of bonding substrates, especially to minimise noise due to vibrations.

### BACKGROUND OF THE INVENTION

Manufactured products often contain hollow parts that result from the manufacturing process and/or that are designed into the product for various purposes, such as weight reduction. Automotive vehicles, for example, include several such hollow parts throughout the vehicle, including in the vehicle's roof, engine hood, trunk hood and in vehicle doors. It is often desirable to connect/bond the parts/substrates forming the hollow parts additionally at least at certain places so as to minimise vibrations and noise through such vibrations caused upon movement of the vehicle.

A suitable rubber composition to connect these parts/substrates for vibration reduction is able to expand its volume when heat is applied in order to increase its flexibility and to reduce alterations of the surface on the bonded parts also called “read-through” for aesthetic reasons. For example, during the manufacture process of a vehicle, the hollow parts of a vehicle's roof can contain applied beads of an uncured rubber composition between roof beam and the roof layer and can still be largely covered by an electro-coating liquid while applied beads of an uncured rubber composition between upper and the lower roof layer are already inserted, and afterwards during a heat treatment step, the expandable rubber composition expands and firmly connects the two layers in order to minimise vibrations and noise through such vibrations caused upon movement of the vehicle.

Known processing oils include various oils as are known in the art, including aromatic, paraffinic, naphthenic and vegetable oils (other than castor oil).

Process oils used in rubber composition allow the transition of highly viscous rubbers with solid appearance into a pumpable material. While providing improved processability, the drawback of using process oils in rubber formulations lies in their low evaporation resistance. Especially at higher temperatures, a considerable amount of process oils can be emitted from the cured material. This can be traced down via solid content measurements, VOC measurements or fogging experiments.

It is thus desirable to obtain a thermally expandable rubber composition that does not suffer from this limitation and exhibits good applicability, especially at temperatures between 10-80° C., as well as other material properties after curing, especially good adhesion on substrates, especially metal substrates.

### SUMMARY OF THE INVENTION

It is an object of the present invention to provide a thermally expandable rubber composition that provides low VOC content and exhibits good applicability as well as other material properties after full curing, especially above 200° C. for 40 min, especially good adhesion on substrates, especially metal substrates.

Surprisingly, the present invention provides a solution to that problem by providing a rubber composition, comprising
a) at least one solid rubber A from the group consisting of styrene-butadiene rubber, cis-1,4-polybutadiene, synthetic isoprene rubber, natural rubber, ethylene-propylene-diene rubber (EPDM), nitrile rubber, butyl rubber and acrylic rubber;
b) processing oil PO, comprising at least one Treated Distillate Aromatic Extract (TDAE);
c) at least one vulcanization system VS,
d) at least one filler G;
e) at least one blowing agent BA,

whereby the total amount of the at least one solid rubber A is between 5 and 30 wt-%, based on the total weight of the rubber composition.

The composition according to the present invention is particularly suitable to be used in vibration reduction, for example in automotive applications. Further aspects of the present invention are subject of other independent claims. Preferred embodiments of the invention are subject of dependent claims.

### DETAILED DESCRIPTION OF THE INVENTION

The unit term “wt.-%” means percentage by weight, based on the weight of the respective total composition, if not otherwise specified. The terms “weight” and “mass” are used interchangeably throughout this document.

Volume changes on the thermally expandable material are determined using the DIN EN ISO 1183 method of density measurement (Archimedes principle) in deionised water in combination with sample mass determined by a precision balance.

The present invention comprises a) at least one solid rubber A from the group consisting of styrene-butadiene rubber, cis-1,4-polybutadiene, synthetic isoprene rubber, natural rubber, ethylene-propylene-diene rubber (EPDM), nitrile rubber, butyl rubber and acrylic rubber.

Preferred solid rubbers have a molecular weight of 100′000 or more.

Preferably, the total amount of the at least one solid rubber A is between 7.5 and 25 wt-%, 7.5 and 20 wt-%, 7.5 and 15 wt-%, most preferred between 7.5 and 12.5 wt-%, based on the total weight of the rubber composition.

Preferably the at least one solid rubber A contains a styrene-butadiene rubber A1. Preferably, the styrene-butadiene rubber A1 is an emulsion-polymerized SBR rubber. These can be divided into two types, cold rubber and hot rubber depending on the emulsion polymerization temperature, but hot rubbers (hot type) are preferred .

Preferably, the styrene-butadiene rubber A1 has a styrene content of from 1 to 60% by weight, preferably from 2 to 50% by weight, from 10 to 40% by weight, from 20 to 40% by weight, most preferred 20 to 30% by weight.

Particularly preferred pre-crosslinked styrene-butadiene elastomer are Petroflex™ SBR 1009A, 1009S and 1018 elastomers, manufactured by Petroflex, Brasil, using either rosin or fatty acids soaps as emulsifier and coagulated by the salt-acid method, and SBR 1009, 1009A and 4503 elastomers, manufactured by ISP Corporation, Tex., USA, by hot emulsion0 polymerization with divinylbenzene.

Preferred styrene-butadiene rubber A1 have a Mooney viscosity (ML 1+4 at 100° C.) of 40-150 MU (Mooney units), preferably 40-100 MU, 55-80 MU. Preferably, Mooney viscosity refers to the viscosity measure of rubbers. It is defined as the shearing torque resisting rotation of a cylindrical metal disk (or rotor) embedded in rubber within a cylindrical cavity. The dimensions of the shearing disk viscometer, test temperatures, and procedures for determining Mooney viscosity are defined in ASTM D1646.

Preferably the at least one solid rubber A contains a cis-1,4-polybutadiene A2.

Preferred cis-1,4-polybutadiene A2 have a cis-1,4-content greater than 90% by weight, preferably greater than 95% by weight.

Preferred cis-1,4-polybutadiene A2 have a Mooney viscosity (ML 1+4 at 100° C.) of 20-80 MU (Mooney units), preferably 20-60 MU, 30-50 MU.

Preferably, Mooney viscosity refers to the viscosity measure of rubbers. It is defined as the shearing torque resisting rotation of a cylindrical metal disk (or rotor) embedded in rubber within a cylindrical cavity. The dimensions of the shearing disk viscometer, test temperatures, and procedures for determining Mooney viscosity are defined in ASTM D1646.

It is especially preferred if the least one solid rubber A is selected from styrene-butadiene rubber A1 and cis-1,4-polybutadiene A2.

Preferably, the weight ratio between styrene-butadiene rubber A1 and cis-1,4-polybutadiene A2 is from 4:1-1:2, preferably from 3:1-1:1, most preferably from 2.5:1-1.5:1.

The present invention comprises b) processing oil PO, comprising at least one Treated Distillate Aromatic Extract (TDAE). This specific kind of aromatic oil is obtained from crude oil for example by vacuum extraction, followed by solvent extraction and a second extraction step.

Such processing oil PO are advantageous for good miscibility with the before mentioned solid rubber A. They are further advantageous in order to obtain low VOC emission especially using the test in the experimental section. Further, it was surprisingly found that they lead to superior adhesion on metal substrates, especially oiled metal substrates. In addition, it was surprisingly found that changes in the total amount of TDAE in the rubber composition have little impact on the viscosity of the rubber composition. This gives great flexibility with respect to formulation of compositions

These TDAE preferably have a content of polycyclic aromatic compounds (PCA) of 3 wt.-% or less, preferably 2.8 wt.-% or less, more preferably 2.6 wt.-% or less, measured according to IP (The Institute of Petroleum) 346 method (PCA standard test).

It is further preferred if the TDAE contains between 20-30 wt.-% of aromatic carbon atoms (Carbon Structure X(A)), 25-35 wt.-% of naphthenic carbon atoms (Carbon Structure X(N)), 40-50 wt.-% of paraffinic carbon atoms (Carbon Structure X(P)), determined by the method DIN 51378.

It is further preferred if the TDAE has a kinematic viscosity at 40° C. of 200-600 mm²/s, measured according to DIN 51562 T. 1.

It is further preferred if the TDAE has a content of aromatic substances, according to ASTM D 2007, of 50-70 wt.-%, preferably 55-65 wt.-%.

It is further preferred if the processing oil PO consists of more than 50 wt.-%, 60 wt.-%, 80 wt.-%, more than 90 wt.-%, preferably 95 wt.-%, most preferably more than 99 wt.-% of TDAE, based on the total amount of processing oil PO.

Preferably, the total amount of the processing oil PO is between 20 and 50 wt-%, preferably between 20 and 40 wt-%, most preferably between 25 and 35 wt-%, based on the total weight of the rubber composition.

Preferably the weight ratio between the processing oil PO and the solid rubber A (PO/A) is from 1-10, 1.5-8, 1.5-6, 1.5-4, preferably from 2-3.

The rubber composition comprises c) at least one vulcanization system VS.

A large number of vulcanization systems based on elementary sulfur as well as vulcanization systems not containing elementary sulfur are suitable.

If a vulcanization systems based on elementary sulfur is used, a system containing pulverulent sulfur is preferred. Such a vulcanization system preferably consists of 1 wt. % to 15 wt. %, preferably 5 wt. % to 10 wt. %, of pulverulent sulfur.

Preferably, vulcanization systems without elementary sulfur compounds are used.

These vulcanization systems without elementary sulfur include vulcanization systems based on organic peroxides, polyfunctional amines, quinones, p-benzoquinone dioxime, p-nitrosobenzene and dinitrosobenzene, as well as vulcanization systems crosslinked with (blocked) diisocyanates.

Preferably, these vulcanization systems with or without elementary sulfur can further comprise organic vulcanization accelerators as well as zinc compounds.

Organic vulcanization accelerators that are suitable include the dithiocarbamates (in the form of their ammonium or metal salts), xanthogenates, thiuram compounds (monosulfides and disulfides), thiazole compounds, aldehyde-amine accelerators (e.g. hexamethylenetetramine) as well as guanidine accelerators, most particularly preferred being dibenzothiazyl disulfide (M BTS).

These organic accelerators are used in amounts of between 0.5 and 3 wt. %, referred to the overall rubber composition.

Zinc compounds acting as vulcanization accelerators may be selected from zinc salts of fatty acids, zinc dithiocarbamates, basic zinc carbonates as well as, in particular particulate zinc oxide. The content of zinc compounds is preferably in the range between 0.5 and 3, 1 and 3, based on the overall rubber composition.

Preferably, the vulcanization system VS is a vulcanization system without elementary sulfur, preferably containing p-benzoquinone dioxime, that further comprises organic vulcanization accelerators, preferably dibenzothiazyl disulfide, as well as zinc compounds, preferably zinc oxide. Preferably such a vulcanization system is present in an amount of 1 and 8 wt.-%, preferably 2 and 7 wt.-%, more preferably 3 and 6 wt.-%, based on the weight of the overall rubber composition.

The rubber composition comprises d) at least one filler G.

Suitable as fillers are, e.g., ground or precipitated calcium carbonate, lime, calcium-magnesium carbonate, talcum, gypsum, graphite, barite, silica, silicates, mica, wollastonite, carbon black, or the mixtures thereof, or the like. Preferably the filler G is selected from ground calcium carbonat, precipitated calcium carbonate and lime.

Preferably, the total amount of the at least one filler G is between 30 and 60 wt-%, preferably between 35 and 55 wt-%, most preferably between 40 and 50 wt-%, based on the total weight of the rubber composition. In case the amount is more than 60 wt-% the viscosity might increase too much. An amount of less than 30 wt-% leads to a reduction in in sag resistance.

The addition of at least one filler G has a positive influence on the smoothness/appeal of the surface structure of the cured composition. It is further advantageous for obtaining closed pored foamed compositions after curing.

The rubber composition comprises e) at least one blowing agent BA.

A suitable blowing agent may be a chemical or physical blowing agent. Chemical blowing agents are organic or inorganic compounds that decompose under influence of, e.g., temperature or humidity, while at least one of the formed decomposition products is a gas. Physical blowing agents include, but are not limited to, compounds that become gaseous at a certain temperature. Thus, both chemical and physical blowing agents are suitable to cause an expansion in the thermally expandable composition.

Preferred chemical blowing agents include but are not limited to azo compounds, hydrazides, nitroso compounds, carbamates, and carbazides.

Chemical blowing agents are preferred for the present inventive composition. Suitable chemical blowing agents are, e.g., azodicarbonamide, azoisobutytronitrile, azocyclohexyl nitrile, dinitrosopentamethylene tetramine, azodiamino benzene, benzene-1,3-sulfonyl hydrazide, calcium azide, 4,4′-diphenyldisulphonyl azide, p-toluenesulphonyl hydrazide, p-toluenesulphonyl semicarbazide, 4,4′-oxybis(benzenesulphonylhydrazide), trihydrazino triazine, and N,N′-dimethyl-N,N′-dinitrosoterephthalamide, and combinations thereof and the like.

Also suitable are dual chemical systems, such as acid/base systems that generate gases upon reaction. One preferred example is sodium hydrogen carbonate and citric acid, a system that generates carbon dioxide when combined in a suitable medium.

Suitable physical blowing agents include expandable microspheres, consisting of a thermoplastic shell filled with thermally expandable fluids or gases. An example for such suitable microspheres are Expancel® microspheres (by AkzoNobel).

Preferably, the blowing agent is included in the present inventive composition with an amount of between 0.1 and 5 wt.-%, 0.1 and 3 wt.-%, 0.1 and 2 wt.-%, preferably between 0.15 and 1 wt.-%, more preferably between 0.2 and 0.6 wt.-%, based on the total weight of the rubber composition.

The rubber composition preferably further comprises f) at least one cyclohexane polycarboxylic acid ester CE.

Such cyclohexane polycarboxylic acid ester CE are advantageous for good surface structure (appearance) and the handling (low tackiness) of the cured rubber composition. It was further surprisingly found that independent of the mixing ratio between the processing oil PO and the cyclohexane polycarboxylic acid ester CE the viscosity of the composition does not change. This gives great flexibility with respect to formulation of compositions.

Preferably the cyclohexane polycarboxylic acid ester is an ester based on 1,2-Cyclohexane dicarboxylic acid, most preferably diisononyl cyclohexane-1,2-dicarboxylate. A commercial available example of diisononyl cyclohexane-1,2-dicarboxylate is Hexamoll DINCH from BASF.

Preferably the weight ratio between the processing oil PO and the cyclohexane polycarboxylic acid ester CE (PO/CE) is from 1-100, 1.5-100, 2.3-100, 2.3-50, 2.3-20, preferably from 2.3-9, most preferably from 3-8. Such a ratio is advantageous for good expansion behaviour.

It might be further preferred if the weight ratio between the processing oil PO and the cyclohexane polycarboxylic acid ester CE (PO/CE) is from 1-20, 1-10, preferably from 1-9, most preferably from 1-8. Such a ratio is advantageous for good surface structure (appearance) and the handling (low tackiness) of the cured composition.

Preferably the weight ratio between the sum of processing oil PO and the optionally present cyclohexane polycarboxylic acid ester CE (PO+CE) and the sum of the solid rubber A ((PO+CE)/(solid rubber A)) is from 1.8-5.5, 2.3-5.5, 2.6-5.0, 3.0-4.5, preferably from 3.25-4.0, most preferably from 3.4-4.0. Such a ratio is advantageous for good expansion behaviour.

Apart from the essential ingredients, the present inventive rubber composition may contain other components commonly used in such compositions and known to the ordinarily skilled artisan in the field. These include, for example colorants, adhesion promoters, antioxidants and the like.

The rubber composition preferably has a viscosity of 30 to 4000 Pas at 25° C., preferably from 300 to 1000 Pas at 25° C.

The rubber composition preferably has a viscosity of 30 to 4000 Pas at 25° C., preferably from 200 to 800 Pas at 45° C.

The viscosity is measured here by oscillographic means using a rheometer having a heatable plate (MCR 301, AntonPaar) (gap 1000 μm, measurement plate diameter: 25 mm (plate/plate), deformation 0.01 at 5 Hz, temperature: 25° C.).

The rubber composition preferably has a VOC value determined according to VDA 278 of below 0.5. It is further preferred if the rubber composition has a FOG value determined according to VDA 278 of below 1.5 mg/g. It is further preferred if the rubber composition has a fog number below 60 according to SAE J1756 (fogging test ford).

Preferably the values for VOC, FOG and fog number are determined as mentioned in the experimental section.

The cured rubber composition preferably has a volume increase compared to the uncured composition of between 10-300%, preferably 20-200%, most preferred 40-70%. Preferably the volume increase is determined using the DIN EN ISO 1183 method of density measurement (Archimedes principle) in deionised water in combination with sample mass determined by a precision balance.

Preferably the values for volume increase (expansion) are determined as mentioned in the experimental section.

The compositions according to the present inventions can be manufactured by mixing the components in any suitable mixing apparatus, e.g. in a dispersion mixer, planetary mixer, double screw mixer, continuous mixer, extruder, or dual screw extruder.

Preferably, the at least one solid rubber A and the processing oil PO are mixed in a separate step using a kneader, preferably a sigma blade kneader until a homogenous mixture is obtained. This homogenous mixture is then preferably mixed with the remaining components of the rubber composition in the suitable mixing apparatus mentioned above.

It may be advantageous to heat the components before or during mixing, either by applying external heat sources or by friction generated by the mixing process itself, in order to facilitate processing of the components into a homogeneous mixture by decreasing viscosities and/or melting of individual components. However, care has to be taken, e.g. by temperature monitoring and use of cooling devices where appropriate, not to exceed the activation temperatures of the blowing agent and/or vulcanization system VS.
A further aspect of the present invention relates to a method of bonding substrates, especially metal substrates, comprising the steps of
a) applying a rubber composition of the invention as defined above to a first substrate, especially a metal substrate, more preferably an oiled metal substrate;
b) contacting the rubber composition applied with a second substrate, especially a metal substrate, more preferably an oiled metal substrate; and
c) curing the rubber composition in the joined substrates at a temperature in the range from 150 to 220° C.

The first and/or second substrate, especially metal substrate, may each be used as such or as part of an article, i.e. of an article comprising the first or second substrate, especially metal substrate. Preferably, the substrates, especially metal substrates, more preferably oiled metal substrates, are used as such. The first and second substrates, especially metal substrates, may be made from the same or different materials.

The first and/or second substrates are preferably metal substrates. If appropriate, however, heat-resistant plastics, are also conceivable as first and/or second substrate.

Suitable first and/or second metal substrates are in principle all the metal substrates known to the person skilled in the art, especially in the form of a sheet, as utilized, for example, in the construction of modes of transport, for example in the automobile industry, or in the production of white goods. Preferably these metal substrates are oiled substrates meaning they are covered with corrosion protection oils known to the person skilled in the art. An example of such a corrosion protection oil is Anticorit PL 3802-39S.

Examples of the first and/or second metal substrate are metal substrates, especially sheets, of steel, especially electrolytically galvanized steel, hot-dip galvanized steel, bonazinc-coated steel, and subsequently phosphated steel, and also aluminium, especially in the variants that typically occur in automaking, and also magnesium or magnesium alloys. Preferably the substrates are oiled substrates.

The rubber composition is applied to the first substrate, especially metal substrate, in step (a) of the method of the invention. This is effected, for example, at an application temperature of the rubber composition of 10° C. to 80° C., preferably of 25° C. to 50° C., more preferably of 30 to 40° C. The application is preferably effected in the form of a bead. Automatic application is preferred.

The rubber composition can be applied over the entire surface or over part of the surface of the first substrate, especially metal substrate. In a typical application, the rubber composition can be applied, for example, only on a part, preferably less than 20%, less than 10%, less than 5%, preferably less than 2%, of the surface of the substrate facing the second substrate.

In a further step, the rubber composition applied to the first substrate, especially metal substrate, is contacted with the second substrate, especially metal substrate. After that the first and the second substrate can then preferably be further fixed by mechanical fixation, like spot welding or riveting, to prevent displacement of the joined substrates.

To cure the rubber composition in the joined substrates, the rubber composition is heated to a temperature in the range from 150 to 220° C., 160 to 200° C., preferably 170 to 190° C. The heating can be effected, for example, by means of infrared radiation or induction heating or in an oven, for example a cathodic electrocoating oven. In this way, the substrates joined with the rubber composition is obtained.

Preferably the duration of said heating step is from 10-60 min, preferably 15-40 min, most preferably 20-30 min.

The rubber composition in the joined substrates can be cured in one step, but curing in two or more steps is also possible, in which case intermediate operating steps between or during the curing steps are possible, for example a wash and/or a dip-coating operation, for example a cathodic electrocoating operation, of one or both substrates, especially metal substrates, with a subsequent wash.

The rubber composition of the invention and the method of the invention are especially suitable for bonding of substrates, especially metal substrates, for the manufacture of modes of transport, especially automobiles, buses, trucks, rail vehicles, ships or aircraft, or white goods, especially washing machines, tumble dryers or dishwashers, or parts thereof, preferably motor vehicles or installable components thereof.

Hence another aspect of the present invention is an article obtained from said method, especially a construction of modes of transport, especially in the automobile industry, or an article of white goods.

Hence another aspect of the present invention is the use of the rubber composition as described above for bonding and/or sealing, especially bonding, of substrates, especially metal substrates, for the manufacture of modes of transport, especially automobiles, buses, trucks, rail vehicles, ships or aircraft, or white goods, especially washing machines, tumble dryers or dishwashers, or parts thereof, especially to reduce vibrations and noised through such vibrations caused upon movement of the bonded substrates.

The invention is further explained in the following experimental part which, however, shall not be construed as limiting the scope of the invention.

### EXAMPLES

Chemicals used for formulating rubber compositons:

TABLE 1

| Ingredient | Description |
|---|---|
| Solid rubber A1 | styrene-butadiene rubber, solid, Mooney viscosity 55-80 (ML |
| | 1 + 4 at 100° C., ASTM D1646), styrene content 20-30% |
| Solid rubber A2 | cis-1,4-polybutadiene, solid, Mooney viscosity 30-50 (ML 1 + 4 |
| | at 100° C., ASTM D1646), cis-1,4-content greater than 95% |
| Naphthenic | CAS: 64742-52-5, Distillates (petroleum) hydrotreated heavy |
| processing oil | naphthenic |
| Paraffinic | CAS No. 64742-65-0, Solvent-dewaxed heavy paraffinic |
| processing oil | distillate |
| Vegetable oil | Vegetable oil based on safflower oil |
| TDAE | Vivatec 500, treated, distilled aromatic extract, Polycyclic |
| | aromatic hydrocarbons (PCA) content 2.6 wt.-% (IP 346), |
| | kinematic viscosity at 40° C. of 410 mm2/s (DIN 51562 T. 1), |
| | content of aromatic substances 61.7 wt.-% (ASTM D 2007), |
| | ansen & Rosenthal KG (Germany) |
| CaCO₃, natural | natural ground calcium carbonate |
| CaCO₃, | precipitated calcium carbonate |
| precipitated | |
| Lime | Lime, ground |
| Vulcanisation | Mixture comprising p-benzoquinone dioxime, dibenzothiazyl |
| system | disulfide and zinc oxide in powder form. |
| DNTP | dinitrosopentamethylene tetramine, blowing agent |
| DINCH | Diisononyl cyclohexane-1,2-dicarboxylate, Hexamoll DINCH, |
| | BASF |

All inventive and non-inventive example compositions shown in table 2 and table 3 were prepared according to the following procedure: In a first step, the solid rubber A1 and solid rubber A2 were mixed in a sigma blade kneader for 15 min. After that, the processing oils were added constantly over a time of 5 hours. After this, the obtained mixture and all the remaining components were added into a speed mixture (total weight of the final composition approximately 300 g) and mixed during 3 min. The mixed rubber compositions were then stored in sealed cartridges.

TABLE 2

| | Composition | | | | | | | | | | | | | | | | | |
|---|---|---|---|---|---|---|---|---|---|---|---|---|---|---|---|---|---|---|
| Ingredient | A | B | C | D | 1 | 2 | 3 | 4 | 5 | 6 | 7 | 8 | 9 | 10 | 11 | 12 | 13 | 14 |
| Solid rubber A1 | 6.4 | 6.4 | 6.4 | 6.4 | 6.4 | 6.4 | 6.4 | 6.4 | 6.4 | 6.4 | 6.4 | 6.4 | 6.4 | 6.4 | 6.4 | 6.4 | 6.4 | 6.4 |
| Solid rubber A2 | 3.6 | 3.6 | 3.6 | 3.6 | 3.6 | 3.6 | 3.6 | 3.6 | 3.6 | 3.6 | 3.6 | 3.6 | 3.6 | 3.6 | 3.6 | 3.6 | 3.6 | 3.6 |
| Naphthenic | | 18.8 | | | 18.8 | | | | 15 | 12.4 | | | | | | | | |
| Paraffinic | 37.6 | 18.8 | | | 18.8 | | | | 15 | 12.4 | | | | | | | | |
| Vegetable oil | | | 37.6 | | | 37.6 | | | | | | | | | | | | |
| TDAE | | | | 37.6 | | | 37.6 | 37.6 | | | 30.1 | 24.8 | | | | 22.9 | 26.3 | 11.3 |
| DINCH | | | | | | | | | | | | | 37.6 | 30.1 | 24.8 | 9.8 | 11.3 | 26.3 |
| CaCO3, | | | | | 33 | 33 | 33 | 38 | 33 | 33 | 33 | 33 | 33 | 33 | 33 | 33 | 33 | 33 |
| natural | | | | | | | | | | | | | | | | | | |
| CaCO₃, | | | | | 10 | 10 | 10 | 10 | 10 | 10 | 10 | 10 | 10 | 10 | 10 | 10 | 10 | 10 |
| precipitated | | | | | | | | | | | | | | | | | | |
| Lime | | | | | 4 | 4 | 4 | 4 | 4 | 4 | 4 | 4 | 4 | 4 | 4 | 4 | 4 | 4 |
| Vulcanisation | | | | | 5 | 5 | 5 | 5 | 5 | 5 | 5 | 5 | 5 | 5 | 5 | 5 | 5 | 5 |
| DNTP | | | | | 0.4 | 0.4 | 0.4 | 0.4 | 0.4 | 0.4 | 0.4 | 0.4 | 0.4 | 0.4 | 0.4 | 0.4 | 0.4 | 0.4 |
| Sum (parts) | 47.6 | 47.6 | 47.6 | 47.6 | 100 | 100 | 100 | 105 | 92.4 | 87.2 | 92.5 | 87.2 | 100 | 92.5 | 87.2 | 95.1 | 100 | 100 |
| miscible | no | yes | yes | yes | | | | | | | | | | | | | | |
| Ratio (TDAE + | 0 | 0 | 0 | 3.76 | 0 | 0 | 3.76 | 3.76 | 0 | 0 | 3.01 | 2.48 | 3.76 | 3.01 | 2.48 | 3.27 | 3.76 | 3.76 |
| DINCH)/solid | | | | | | | | | | | | | | | | | | |
| rubber A | | | | | | | | | | | | | | | | | | |
| Ratio (TDAE/ | — | — | — | — | — | — | — | — | — | — | — | — | 0 | 0 | 0 | 2.34 | 2.33 | 0.43 |
| DINCH) | | | | | | | | | | | | | | | | | | |

TABLE 3

| | Composition | | | | | | | |
|---|---|---|---|---|---|---|---|---|
| Ingredient | 15 | 16 | 17 | 18 | 19 | 20 | 21 | 22 |
| Solid rubber A1 | 6.4 | 6.4 | 6.4 | 6.4 | 6.4 | 6.4 | 6.4 | 6.4 |
| Solid rubber A2 | 3.6 | 3.6 | 3.6 | 3.6 | 3.6 | 3.6 | 3.6 | 3.6 |
| Naphthenic | | | | | | | | |
| processing oil | | | | | | | | |
| Paraffinic | 26.3 | 11.3 | | | 3.8 | 7.5 | 11.3 | 9 |
| processing oil | | | | | | | | |
| Vegetable oil | | | | | | | | |
| TDAE | | | 32 | 27.4 | 33.8 | 30.1 | 26.3 | 21 |
| DINCH | 11.3 | 26.3 | 3.6 | 6.8 | | | | |
| CaCO3, natural | 33 | 33 | 33 | 33 | 33 | 33 | 33 | 33 |
| CaCO₃, | 10 | 10 | 10 | 10 | 10 | 10 | 10 | 10 |
| precipitated | | | | | | | | |
| Lime | 4 | 4 | 4 | 4 | 4 | 4 | 4 | 4 |
| Vulcanisation | 5 | 5 | 5 | 5 | 5 | 5 | 5 | 5 |
| system | | | | | | | | |
| DNTP | 0.4 | 0.4 | 0.4 | 0.4 | 0.4 | 0.4 | 0.4 | 0.4 |
| Sum (parts) | 100 | 100 | 98 | 96.6 | 100 | 100 | 100 | 92.4 |
| Ratio (TDAE + | 1.13 | 2.63 | 3.56 | 3.42 | 3.38 | 3.01 | 2.63 | 2.1 |
| DINCH)/solid | | | | | | | | |
| rubber A | | | | | | | | |
| Ratio (TDAE/ | 0 | 0 | 8.89 | 4.03 | — | — | — | — |
| DINCH) | | | | | | | | |

Test of Processing Oils for Compatibility/Miscibility with Solid Rubber A:

The processing oils of table 1 (naphthenic processing oil, paraffinic processing oil, a mixture thereof, vegetable oil and TDAE) were tested for their compatibility/miscibility with the solid rubber A, see table 2, Ex.A-D.

The components shown were mixed in a sigma blade kneader. After addition of solid rubber A1 and solid rubber A2, the processing oils were added constantly over a time of 5 hours and inspected 15 minutes after addition of the final amount of processing oil. The miscibility of the processing oils was judged by eye; a complete dissolving/mixing in of the processing oils was rated “miscible”=yes, undisoved/separated processing oil was rated “miscible”=no. The results are shown in table 2.

It was found that compositions with paraffinic oil (Ex.A) alone was not miscible. However, miscible were compositions with a mixture of naphthenic oil and paraffinic oil (Ex.B), compositions with vegetable oil based (Ex.C) and compositions with TDAE (Ex.D).

VOC/FOG Measurements

VDA 278

The VDA 278 norm describes an analytical method to determine emissions from parts or adhesives that are used in motor vehicles. The method comprises a thermodesorption step (emission of volatile substances by heating up small amounts of test materials according to a defined process), a cryofocus step (immobilization of volatile substances in a cold trap) and a quick heating step to 280° C. to evaporate the volatile substances. The volatiles are then split up by gas-chromatographic separation and single substances are detected by mass spectrometry.

In this method, two semi-quantitative cumulative values are determined, a VOC value (total of readily volatile to medium volatile substances calculated as toluene equivalents up to n-pentacosane, C25) and a FOG value (low volatility substances calculated as hexadecane equivalents, in the boiling range up to C14 to C32 n-alcanes, readily condensing at room temperature). To determine the VOC value the sample is heated up to 90° C. for 30 min. The FOG value is determined by re-heating the sample used for generating the VOC value to 120° C. for 60 min. The VDA 278 norm does not define acceptable limits for VOC and FOG values.

Preferred values are in the range of below 0.5 and below 1.5 mg/g for VOC and FOG, respectively.

SAE J1756 (Fogging Test Ford)

The norm describes a method to determine the tendency of interior materials in automotive to produce a light scattering deposit (fog) on a glass surface. The method comprises a thermodesorption step (100° C. for 3h) of a defined amount of material (10.0 g) and a simultaneous condensation step of the emitted volatile substances on a cooled glass plate (21° C.). The Fog Number R^{(avg)}/R₀^{(avg)}·100 is then determined by taking the quotient of the 60° reflectance values of the glass plate with condensed volatile substances and the 60° reflectance values of the clean glass plate, multiplied by 100. The readings are taken 1h and 16h after removing the glass plates from the equipment (to account for effects due to moisture equilibration at ambient conditions).

Preferably the Fog Number is below 60.

Solid Content

The solid content was determined by applying Archimedes Principle. The samples were quantified for each sample by measuring the density before and after cuing. The densities were determined according to DIN EN ISO 1183 using the water immersion method (Archimedes principle) in deionised water and a precision balance to measure the mass.

The following curing conditions were used (determination of solid content and expansion measurements):

Under bake condition (UB):

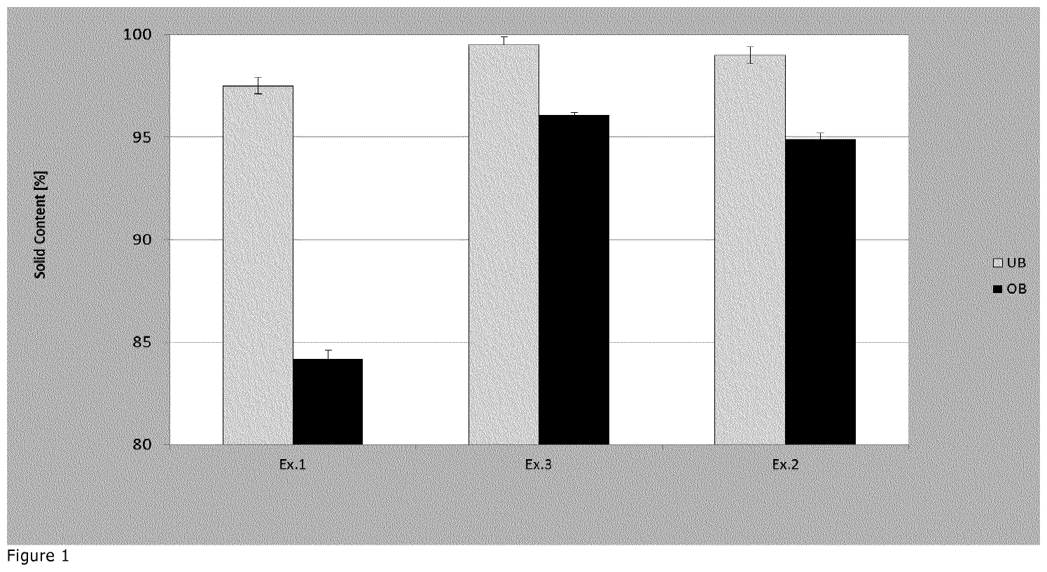

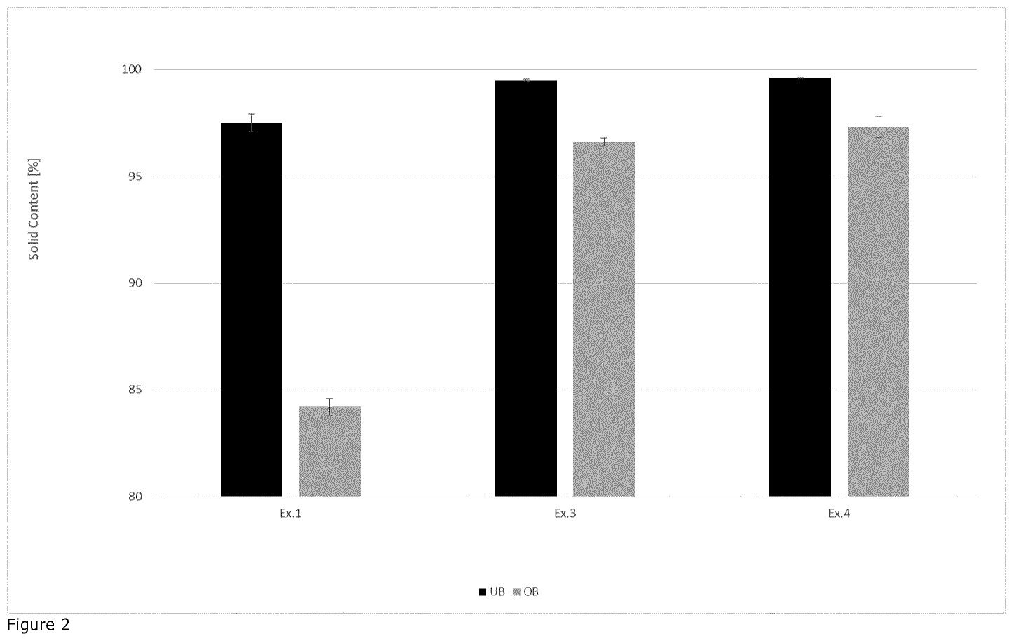

Heating of a sample for 10 minutes on reach curing temperature, curing a 160° C. for 15 min, except for FIGS. 1 and 2 only 10 min.

Normal bake condition (NB):

Heating of a sample for 10 minutes on reach curing temperature, curing a 180° C. for 20 min.

Over Bake Condition (OB):

Heating of a sample for 10 minutes on reach curing temperature, curing a 200° C. for 40 min. except for FIGS. 1 and 2 only 20 min.

TABLE 4

| Composition | Ex. 1 | Ex. 2 | Ex. 3 |
|---|---|---|---|
| VDA 278 | 18 | 3.4 | 1.2 |
| VOC | | | |
| Fog Number | 48 | 11 | 8.4 |
| (mg/g) | | | |

Table 4 shows that the composition containing TDAE (Ex.3) shows lower values for the VDA 278 VOC as well as for the Fog Number(mg/g) than the composition containing a mixture of naphthenic oil and paraffinic oil (Ex.1) or a composition containing vegetable oil based processing oils (Ex.2).

FIG. 1 reveals that the composition containing TDAE (Ex.3) shows a higher solid content after both, UB-condition and OB-condition than the composition containing a mixture of naphthenic oil and paraffinic oil (Ex.1) or a composition containing vegetable oil based processing oils (Ex.2).

Surprisingly, the comparison of Ex.3 with Ex.4 in FIG. 2 reveals that the solid content does not change if the total amount of TDAE in the composition is altered by increasing the amount of filler. This is advantageous since it allows for great flexibility in formulating compositions.

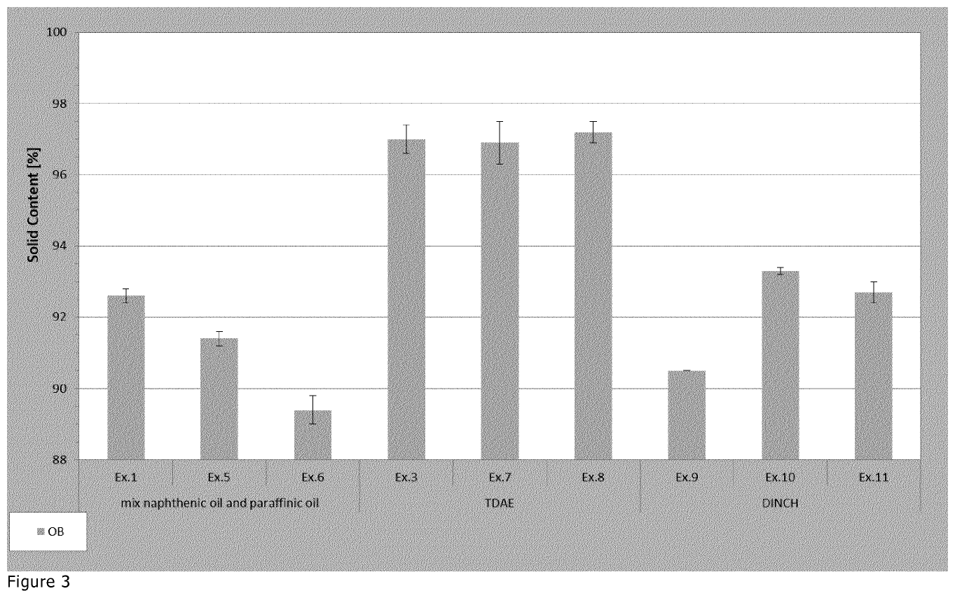

In FIG. 3, it was surprisingly found that reduction of the total amount of TDAE for Ex.3, Ex.7 and Ex.8, the solid content stayed the same. This is an advantage since this leads to great flexibility in composition design for example with respect to amounts of filler or processing oil used.

In contrast, the solid content in the case of a mixture of naphthenic oil and paraffinic oil (Ex.1, Ex.5 and Ex.6) decrease at lower oil loadings.

TABLE 5

| | | | | | |
|---|---|---|---|---|---|
| Ex. 3 | Ex. 7 | Ex. 8 | Ex. 9 | Ex. 10 | Ex. 11 |

UB

| | | | | | | |
|---|---|---|---|---|---|---|
| Tackiness | − − | − − | − − | ++ | ++ | ++ |
| | very | very | very | dry | dry | dry |
| | tacky | tacky | tacky | | | |
| Surface | − − | − − | − − | ++ | ++ | ++ |
| structure | some | some | some | smooth, | smooth, | smooth, |
| | pores | pores | pores | no | no | no |
| | | | | pores, | pores, | pores, |
| | | | | good | good | good |
| | | | | foam | foam | foam |
| | | | | structure | structure | structure |

OB

| | | | | | | |
|---|---|---|---|---|---|---|
| Tackiness | − − | − − | − − | ++ | ++ | ++ |
| | very | very | very | dry | dry | dry |
| | tacky | tacky | tacky | | | |
| Surface | − − | − − | − | + | + | + |
| structure | many | many | many | smooth, | smooth, | smooth, |
| pores, | pores, | pores | some | some | some | |
| | rough | rough | pores, | pores, | pores, | |
| | surface | surface, | | good | good | good |
| | | | | foam | foam | foam |
| | | | | structure | structure | structure |

Table 5 shows an overview over tackiness and surface structure of a bead of rubber composition (50 mm length, 12 mm diameter) after overbake (OB) or underbake (UB) curing conditions.

Compositions containing TDAE (Ex.3, Ex.7-8) exhibited a very tacky surface structures after cure as well as a surface with many open pores, at underbake conditions as well as at overbake conditions.

Compositions containing DINCH showed very good surface properties and no tackiness at both curing conditions.

Combination Process Oils and Plasticizers

FIG. 3 shows the result of a solid content measurement under overbake (OB) curing conditions. Comparison of Ex.3 with Ex.7 and Ex.8 in FIG. 3 shows the effect seen before in FIG. 2 (comparison of Ex.3 with Ex.4) that surprisingly in the case of compositions containing TDAE the solid content does not change if the total amount of TDAE in the composition is altered. This is advantageous for great flexibility in formulating compositions.

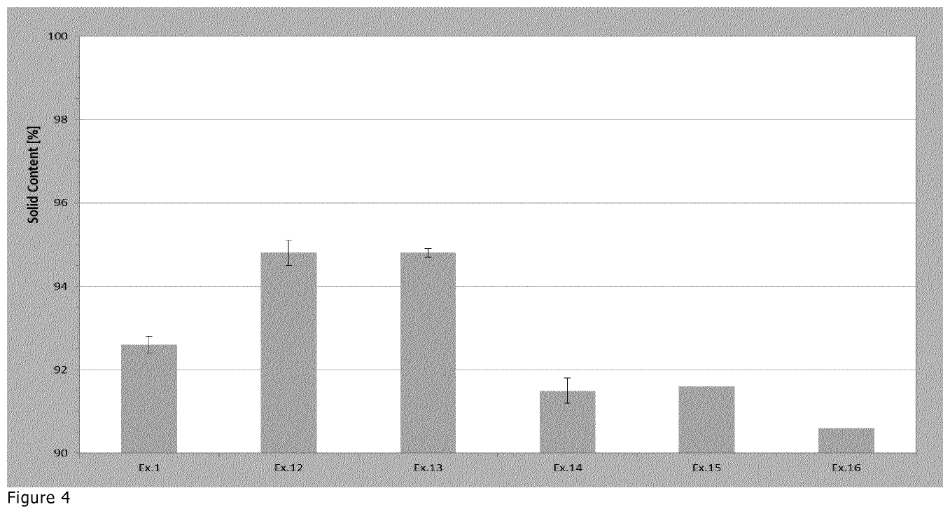

Surprisingly this is also the case in combination with DINCH as shown in FIG. 4 by the comparison of Ex.12 with Ex.13. FIG. 4 shows the result of a solid content measurement under overbake (OB) curing conditions. However, in compositions containing only DINCH alone this effect is not seen, as shown in FIG. 3 by the comparison of Ex.9-11.

Further, the comparison of Ex.13 with Ex.14 shows that compositions containing a mixture of TDAE and DINCH with a high amount of DINCH have a significantly lower solid content.

TABLE 6

| | | | | | | | | |
|---|---|---|---|---|---|---|---|---|
| Ex.19 | Ex.20 | Ex.21 | Ex.22 | Ex. 17 | Ex. 18 | Ex. 12 | Ex. 13 | Ex. 14 |

UB

| | | | | | | | | | |
|---|---|---|---|---|---|---|---|---|---|
| Tackiness | − | − | +/− | +/− | +/− | +/− | +/− | + | ++ |
| | tacky | tacky | slightly | slightly | slightly | slightly | slightly | not | dry |
| | | | tacky | tacky | tacky | tacky | tacky | tacky | |
| Surface | + | + | + | + | ++ | ++ | ++ | ++ | ++ |
| structure | smooth, | smooth, | smooth, | smooth, | smooth, | smooth, | smooth, | smooth, | smooth, |
| | some | some | some | some | no | no | no | no | no |
| | pores | pores | pores | pores | pores | pores | pores | pores | pores |

OB

| | | | | | | | | | |
|---|---|---|---|---|---|---|---|---|---|
| Tackiness | +/− | +/− | + | + | + | + | ++ | ++ | ++ |
| | slightly | slightly | not | not | not | not | dry | dry | dry |
| | tacky | tacky | tacky | tacky | tacky | tacky | | | |
| Surface | − − | − − | − − | − − | − − | +/− | +/− | + | + |
| structure | many | many | many | many | many | pores | pores | smooth, | smooth, |
| | pores, | pores, | pores, | pores, | pores, | | | some | some |
| | rough | rough | rough | rough | rough | | | pores | pores |
| | surface | surface | surface | surface | surface | | | | |

Table 6 shows an overview over tackiness and surface structure of a bead of rubber composition (50 mm length, 12 mm diameter) after overbake (OB) or underbake (UB) curing conditions.

Table 6 displays that compositions containing a combination of TDAE with paraffinic oil usually showed a relatively porous and slightly tacky surface (Ex.19-22).

Compositions containing a combination of TDAE/DINCH showed clearly better surface structures with less pores and less tacky surfaces, see comparison Ex.21 with Ex.12 or Ex.22 with Ex.13.

Especially higher total amounts of TDAE/DINCH combinations, as in formulations Ex.13 and Ex.14, showed a clear improvement and resulted in very nice surface and foam structures at almost no tackiness after cure.

Viscosity:

The viscosity was measured according to DIN 54458 oscillographically by means of a rheometer with heatable plate (MCR 301, AntonPaar) (gap 1000 μm, measuring plate diameter: 25 mm (plate/plate), deformation 0.01-10% at 5 Hz, temperature: 45° C.).

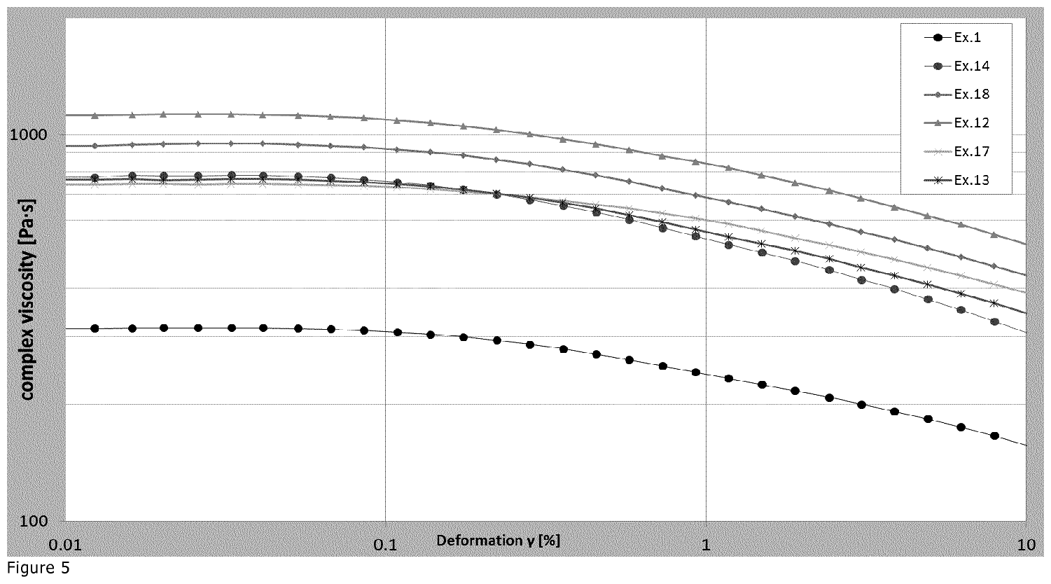

FIG. 5 shows an overview on the viscosities of compositions containing TDAE/DINCH mixtures. Surprisingly it was found that keeping the total concentration of the mixture of TDAE/DINCH constant but changing the ration of TDAE/DINCH did not affect the viscosity, see Ex.13 and Ex.14. This is advantageous since it allows for great flexibility in formulating compositions. Changing the total concentration of the mixture of TDAE/DINCH resulted only in a minor increase the viscosity, compare Ex.12 and Ex.13.

Expansion:

The thermal expansion is measured in volume changes on the thermally expandable material are determined using the DIN EN ISO 1183 method of density measurement (Archimedes principle) in deionised water in combination with sample mass determined by a precision balance. The curing conditions used were the curing conditions for over bake conditions (OB) described before.

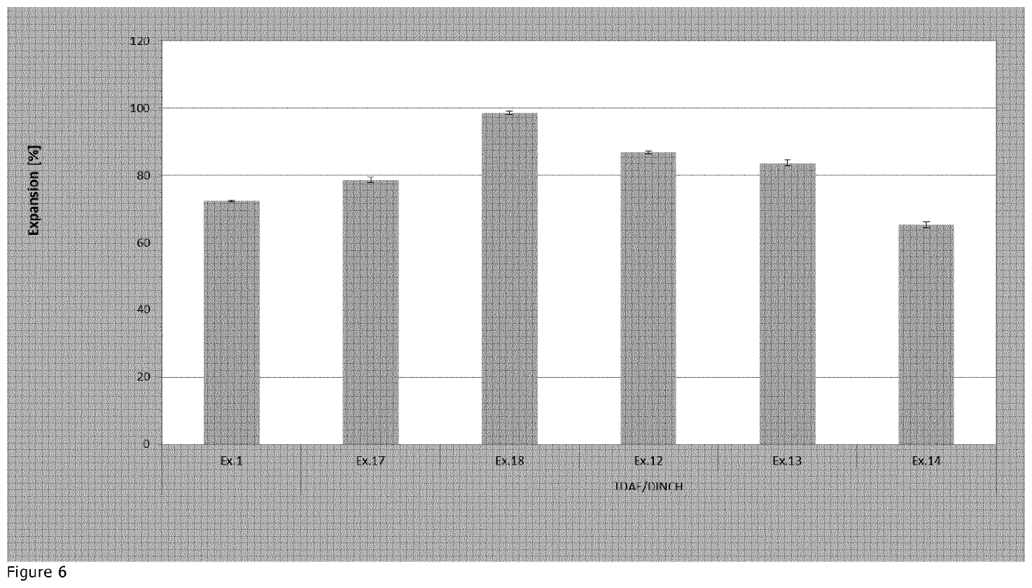

FIG. 6 shows the result of an expansion measurement with OB curing conditions. FIG. 6 shows that high amounts of DINCH in compositions containing a mixture of TDAE and DINCH reduce the expansion upon curing. This is seen for example in the comparison of Ex.13 with Ex.14.

Further, the comparison of Ex.12 with Ex.13 surprisingly shows that variation of total amount of mixture TDAE/DINCH does not significantly alter the expansion rate, giving great flexibility in formulation.

Adhesion on Metal Substrates

Tensile Shear Strength (TSS) (DIN EN 1465)

Cleaned and then oiled with Anticorit PL 3802-39S test specimens of steel (thickness 0.8 mm) were bonded with the compositions on an adhesive surface of 25×20 mm using teflon spacers in a layer thickness of 2.0 mm and cured. Curing conditions: 25 min at 160° C. oven temperature. The tensile shear strength was determined on a tensile machine at a tensile speed of 10 mm/min in a 3-fold determination according to DIN EN 1465.

The following visual assessment of the fracture appearance obtained from tensile shear strength test was used: The results were divided into CF (cohesive fracture) and AF (adhesive fracture) and the amount of the mentioned fracture was determined in % of the total fracture pattern.

When comparing the tensile shear strength of composition Ex.1 with composition Ex.18 it was found that Ex.1 showed a 40% adhesive/60% cohesive failure. Ex.18 on the other hand showed 100% cohesive failure. It was also found that compositions containing the same amount of TDAE like Ex.18 but no DINCH showed 100% cohesive failure as well.

Variation Amount of Solid Rubber

Table 7 shows the result of a variation solid rubber A amounts. Ex.23 shows that compositions with amounts of more than 30 wt.-% of solid rubber A are significantly inferior with respect to miscibility, processability and pumpability. Table 7 further shows that the addition of fillers has a positive influence on the surface and the foam structure of the cured composition.

TABLE 7

| Composition | Ex. 23 | Ex. 24 | Ex. 25 | Ex. 26 | Ex. 27 |
|---|---|---|---|---|---|
| Ingredient | | | | | |
| Solid rubber A1 | 22.4 | 16 | 12.8 | 7 | 5.8 |
| Solid rubber A2 | 12.6 | 9 | 7.2 | 4 | 3.2 |
| TDAE | 41.7 | 48.7 | 41.3 | 25.6 | 27 |
| DINCH | 17.9 | 20.9 | 17.7 | 11 | 11.6 |
| CaCO3, natural | − | − | 11 | 33 | 33 |
| CaCO₃, precipitated | − | − | 3.3 | 10 | 10 |
| Lime | − | − | 1.3 | 4 | 4 |
| Vulcanisation | 5 | 5 | 5 | 5 | 5 |
| DNTP | 0.4 | 0.4 | 0.4 | 0.4 | 0.4 |
| Sum (parts) | 100 | 100 | 100 | 100 | 100 |
| Total solid rubber A | 35 | 25 | 20 | 11 | 9 |
| TDAE + DINCH/solid | 1.7 | 2.8 | 3.0 | 3.3 | 4.3 |
| rubber A | | | | | |
| Miscibility | − | + | −/+ | ++ | ++ |
| Processing | − | + | + | ++ | ++ |
| Pumpability | No | possilbe | possilbe | good | good |
| Surface/Pore | Wrinkly, | Wrinkly, | Wrinkly, open | Smooth, | Smooth, |
| structure after curing | open pores | open pores | pores | closed pores | closed pores |

The compositions Ex.23-27 were mixed and processed as described above for the compositions in table 1-2.

The following rating system was used for “Miscibility” and “Processing”:

Miscability:

not miscable, +/− average miscablility, + good miscablility, ++ very good miscablility

Processing:

not processable, + good processablility, ++ very good processablility The appearance of the cured surface and the pore structure was analysed after curing the compositions for 20 min at 160° C. including heating the samples for 10 min in order to reach the temperature of 160° C.

1. A rubber composition, comprising
a) at least one solid rubber A selected from the group consisting of styrene-butadiene rubber, cis-1,4-polybutadiene, synthetic isoprene rubber, natural rubber, ethylene-propylene-diene rubber (EPDM), nitrile rubber, butyl rubber and acrylic rubber;
b) processing oil PO, comprising at least one Treated Distillate Aromatic Extract (TDAE);
c) at least one vulcanization system VS,
d) at least one filler G;
e) at least one blowing agent BA,
whereby the total amount of the at least one solid rubber A is between 5 and 30 wt-%, based on the total weight of the rubber composition.

2. The rubber composition according to claim 1, wherein the at least one solid rubber A is selected from styrene-butadiene rubber A1 and cis-1,4-polybutadiene A2.

3. The rubber composition according to claim 1, wherein the total amount of the at least one solid rubber A is between 7.5 and 25 wt-%, based on the total weight of the rubber composition.

4. The rubber composition according to claim 2, wherein the weight ratio between styrene-butadiene rubber A1 and cis-1,4-polybutadiene A2 is from 4:1-1:2.

5. The rubber composition according to claim 1, wherein the rubber composition further comprises f) at least one cyclohexane polycarboxylic acid ester CE.

6. The rubber composition according to claim 5, wherein the weight ratio between the processing oil PO and the cyclohexane polycarboxylic acid ester CE (PO/CE) is from 1-100.

7. The rubber composition according to claim 1, wherein the weight ratio between the sum of processing oil PO and the optionally present cyclohexane polycarboxylic acid ester CE (PO+CE) and the sum of the solid rubber A ((PO+CE)/(solid rubber A)) is from 1.8-5.5.

8. The rubber composition according to claim 1, wherein the total amount of the at least one filler G is between 30 and 60 wt-%, based on the total weight of the rubber composition.

9. The rubber composition according to claim 1, wherein the total amount of the processing oil PO is between 20 and 50 wt-%, based on the total weight of the rubber composition.

10. The rubber composition according to claim 1, wherein the total amount of the at least one blowing agent BA is between 0.1 and 5 wt.-%, based on the total weight of the rubber composition.

11. The rubber composition according to claim 1, wherein the at least one vulcanization system VS is a vulcanization system without elementary sulfur that further comprises organic vulcanization accelerators as well as zinc compounds.

12. A method of bonding substrates comprising the steps of
applying a rubber composition according to claim 1 to a first substrate;
b) contacting the rubber composition applied with a second substrate; and
c) curing the rubber composition in the joined substrates at a temperature in the range from 150 to 220° C.

13. An article obtained from the method of claim 12.

14. A method for bonding and/or sealing of substrates for the manufacture of modes of transport or white goods, comprising applying the rubber composition according to claim 1 onto the substrates.
